(19) United States
(12) Patent Application Publication
(10) Pub. No.: US 2010/0173805 A1
(43) Pub. Date: Jul. 8, 2010

(54) USE OF WAX IN OIL-BASED DRILLING FLUID

(75) Inventor: Daniel Guy Pomerleau, Calgary (CA)

Correspondence Address: HESLIN ROTHENBERG FARLEY & MESITI PC, 5 COLUMBIA CIRCLE, ALBANY, NY, 12203, US

(73) Assignee: ENGINEERED DRILLING SOLUTIONS INC., Calgary, AB (CA)

(21) Appl. No.: 12/601,354

(22) PCT Filed: May 22, 2008
(86) PCT No.: PCT/CA2008/001003

§ 371 Date: Feb. 8, 2010

Related U.S. Application Data
(60) Provisional application No. 60/940,447, filed on May 28, 2007.

(51) Int. Cl. C09K 8/18

(52) U.S. Cl. 507/138

(57) ABSTRACT

Compositions and methods for improving the performance of invert drilling fluids are provided. In particular, waxes are used in drilling fluid compositions to improve the performance of organophilic clays within a drilling solution as well as to improve seepage control.

### FIELD OF THE INVENTION

This invention relates to compositions and methods for improving the performance of invert drilling fluids. In particular, the invention relates to the use of waxes in drilling fluid compositions to improve the performance of organophilic clays within a drilling solution as well as improving seepage control.

### BACKGROUND OF THE INVENTION

Oil based drilling fluids and advances in drilling fluid compositions are described in applicant's co-pending application PCT CA2007/000646 filed Apr. 18, 2007 and incorporated herein by reference. This co-pending application describes the chemistry of organoclays and primary emulsifiers for use in various applications including oil-based drilling fluids and various compositions wherein the viscosity of the compositions may be controlled.

By way of background and in the particular case of oil muds or oil-based drilling fluids, organophilic clays have been used in the past 50 years as a component of the drilling fluid to assist in creating drilling fluids having properties that enhance the drilling process. In particular, oil-based drilling fluids are used for cooling and lubrication, removal of cuttings and maintaining the well under pressure to control ingress of liquid and gas. A typical oil-based drilling mud includes an oil component (the continuous phase), a water component (the dispersed phase) and an organophilic clay (hereinafter OC) which are mixed together to form a gel (also referred to as a drilling mud or oil mud). Emulsifiers, weight agents, fluid loss additives, salts and numerous other additives may be contained or dispersed into the mud. The ability of the drilling mud to maintain viscosity and emulsion stability generally determines the quality of the drilling mud.

The problems with conventional oil muds incorporating OCs are losses to viscosity and emulsion stability as well drilling progresses. Generally, as drilling muds are utilized downhole, the fluid properties will change requiring the drill operators to introduce additional components such as emulsifiers into the system to maintain the emulsion stability. The ongoing addition of emulsifiers to the oil mud increases the cost of drilling fluid during a drilling program. Compounding this problem is that the addition of further emulsifying agents to the oil mud has the effect of impairing the ability of OC to maintain viscosity within the drilling fluid which in turn requires the addition of further OCs which a) then further adds to the cost of the drilling fluid and b) then requires the addition of further emulsifiers.

As a result, there continues to be a need for oil-based drilling solutions that have superior viscosity and emulsion stability properties such that the viscosity and emulsion stability of the drillings solutions is both high and stable throughout the drilling program.

The current state-of-the-art in drilling fluid emulsifiers are crude tall oil fatty acids (CTOFAs). Crude tall oil is a product of the paper and pulping industry and is a major byproduct of the kraft or sulfate processing of pinewood. Crude tall oil starts as tall oil soap which is separated from recovered black liquor in the kraft pulping process. The tall oil soap is acidified to yield crude tall oil. The resulting tall oil is then fractionated to produce fatty acids, rosin, and pitch.

The main advantage of CTOFAs is that they are relatively inexpensive as an emulsifier. However, the use of CTOFAs as emulsifiers within oil muds does not produce high and stable viscosity and emulsion stability and does not allow or enable the control of viscosity while optimizing the performance of the organophilic clay.

As a result, there continues to be a need for a class of emulsifying agents that effectively increase or decrease the viscosity and stability of organoclay/water/oil emulsions to provide a greater degree of control over the fluid properties of such emulsions. More specifically, there has been a need for methods and compositions that reduce the costs associated with traditional oil-based drilling fluids whilst providing control over the properties of the composition.

Other emulsifiers as described in Applicant's co-pending application include saturated fatty acids, blends of saturated fatty acids, blends of saturated and unsaturated fatty acids, a vegetable oil selected from any one of safflower oil, olive oil, cottonseed oil, coconut oil, peanut oil, palm oil, palm kernel oil, and canola oil and tallow oil.

In addition to the design of the drilling fluid for its viscosity and emulsion stability, it is necessary that drilling fluid engineers factor into the drilling plan the cost of drilling fluid losses to the formation due to the porosity and fractures within the formation as well as fluid losses caused by the removal of drill cuttings from the well that have been coated with drilling fluid.

In many drilling fluid systems, fluid loss may cost an operator $700-$1,000 per m³ of drilling fluid lost based on an average drilling fluid cost of $700-$1000/m³. As a result, in a typical 2000 m drilling program, an operator may expect fluid losses in the range from 70-100 m³ which would cost the operator approximately $49,000 to $100,000 simply in lost fluid.

Seepage losses can be reduced, by varying degrees by adding foreign solids to the fluid. Most of the products in use today are cellulose-based, refined asphalts, calcium carbonates or specially constructed solids. The general objective in preventing seepage control is to plug or build a mat of material in, on, or near the well bore to create a seal between the drilling fluid and underground formations.

As is known, there can be many undesired side effects from solid seepage control additives that affect both the well bore and the drilling fluid properties. For example, solids added to a hydrocarbon/water emulsion may reduce the emulsion stability of the drilling fluid by consuming emulsifiers. The loss of emulsifier must then be offset with the addition of emulsifiers to maintain the desired fluid properties which results in higher fluid costs. It is also known that seepage control agents, such as calcium carbonates, have a relatively high density (typically in the range of 2600 kg/m³) that will increase the overall density of the drilling fluid. The higher density drilling fluid will increase the hydrostatic pressure against the formation and often increase the rate of losses. Further still, solid seepage control agents can degrade during the drilling process, and affect the plastic viscosity and yield point and thereby contribute to a reduction in the particle size distribution (PSD). Other seepage control agents may require that oil wetting chemicals be added to ensure the seepage control agents are oil wet also increasing the cost. Thus, while various formulations are effective in reducing some fluid losses, there continues to be a need for improved technologies to reduce seepage losses.

### SUMMARY OF THE INVENTION

In accordance with the invention, there is provided a method for controlling the viscosity of an oil and water emulsion comprising the step of introducing an effective amount of an emulsifier to an oil and water emulsion containing organophilic clay (OC) to produce a desired viscosity in the emulsion wherein the emulsifier is selected from any one of: beeswax, candelilla wax, carnauba wax, ceresine wax, Montan wax, and shellac.

The amount of emulsifier and organophilic clay are preferably selected to maximize the performance of the organophilic clay for the desired viscosity. The amounts of organophilic clay and emulsifier may also be balanced to minimize the amount of organophilic clay for a desired viscosity wherein the balance is achieved by sequentially increasing the amount of emulsifier to produce the desired viscosity.

The emulsifier may also be selected to improve the seepage control properties of the emulsion. Emulsifiers for improved seepage control are Montan wax and beeswax. Seepage control may also be enhanced by blending an effective amount of fine or coarse gilsonite into the emulsion for seepage control.

Seepage control may also be affected by blending an effective amount of a leonardite into the emulsion as a secondary seepage control agent. The leonardite may be any one of or a combination of a lignite or a coal dust.

The invention also provides a drilling fluid emulsion comprising: a hydrocarbon continuous phase; a water dispersed phase; an organophilic clay; and, an emulsifier selected from beeswax, candelilla wax, carnauba wax, ceresine wax, Montan wax, and shellac to produce a desired viscosity in the emulsion. In one embodiment, the amounts of emulsifier and organophilic clay maximize the performance of the organophilic clay for the desired viscosity. In another embodiment, the organophilic clay and emulsifier are balanced to minimize the amount of organophilic clay to produce the desired viscosity. Both Montan wax and beeswax are effective emulsifiers for seepage control. Seepage control may also be enhanced by additionally incorporating fine or coarse gilsonite. A secondary seepage control agent including leonardite may also be utilized. The leonardite may be any one of or a combination of a lignite or a coal dust.

### DETAILED DESCRIPTION OF THE PREFERRED EMBODIMENT

In accordance with the invention, improved drilling fluid compositions and methods of preparing the drilling fluid compositions are described. The compositions in accordance with the invention have rheological properties that enable their use as effective drilling fluid compositions.

In the context of this description, the compositions and methods described all relate to oil-based drilling solutions that, as described below, include a hydrocarbon continuous phase, a water dispersed phase, an organophilic clay and an emulsifier. The amount of hydrocarbon phase and water phase in a given emulsion may be varied from as low as 50:50 (hydrocarbon:water (v/v)) to as high as 99:1. At the lower end of this range, emulsion stability is substantially lower and the ability to alter viscosity requires that large amounts of organophilic clay be added to the mixture. Similarly, at the upper end, the ability to control viscosity within the emulsion is more difficult. As a result, an approximate hydrocarbon:water ratio of 80:20 to 90:10 (v/v) is a practical ratio that is commonly used for drilling solutions.

In this description, a representative drilling solution having a hydrocarbon:water ratio of 90:10 (v/v) was used as a standard to demonstrate the effect of emulsifiers on the organophilic clay performance, viscosity and emulsion stability. In addition, a relatively narrow range of organophilic clay ratios relative to the total mass of solution was utilized. Each of these amounts was selected as a practical amount to demonstrate the effect of altering the amount of organophilic clay and/or emulsifier relative to the other components. While experiments were not performed across the full range of ratios where such compositions could be made, it would be understood by one skilled in the art that in the event that one parameter was changed that adjustment of another parameter to compensate for the change in other parameters would be made.

Thus, in the context of this description, it is understood that the change in one parameter may require that at least one other parameter be changed in order to optimize the performance of the composition. For example, if the stated objective in creating a composition for a given hydrocarbon:water ratio is to minimize the usage of organophilic clay in that composition, the worker skilled in the art would understand that adjustment of both the amount of organophilic clay and emulsifier in the composition may be required to obtain a composition realizing the stated objective and that such an optimization process, while not readily predictable, is understood by those skilled in the art.

### A. Experimental

### a) Base Solution

A base drilling fluid solution was created for testing whereby individual constituents of the formulation could be altered to examine the effect on drilling fluid properties. The base drilling fluid solution was a miscible mix of a hydrocarbon, water, organophilic clay and emulsifier. The general formulation of the base drilling solution is shown in Table 1.

TABLE 1
Base Drilling Solution

| Component | Volume % | Weight % |
|---|---|---|
| Oil | 90 | |
| Water | 10 | |
| Calcium Chloride (CaCl₂) | | 25 wt % of water |
| Organophilic Clay | | 5.7 wt % of water* |
| Quick Lime (CaO) | | 28.5 wt % of water* |
| Emulsifier | | 0.95 wt % of water* |

*unless otherwise noted

### b) Preparation

The oil, water, calcium chloride and organophilic clay were mixed at high speed to create a highly dispersed slurry. Mixing was continued until the slurry temperature reached 70° C. Emulsifiers were added to individual samples of each solution and again mixed at high speed for 3 minutes. Lime (CaO) was then added and blended for 2 minutes at high speed. The calcium chloride was added in accordance with standard drilling fluid preparation procedures as an additive to provide secondary fluid stabilization as is known to those skilled in the art.

Prior to testing, the samples were subsequently heat aged in hot rolling cells for 18-24 hours to simulate downhole conditions.

### c) Fluid Property Measurements

Viscosity measurements were made using a Fann Variable Speed concentric cylinder viscometer and is the dial reading on the viscometer at the indicated rpm. Data points were collected at 600, 300, 200, 100, 6, and 3 RPM points.

Emulsion stability (ES) was measured using an OFI emulsion stability meter. Each measurement was performed by inserting the ES probe into the solution at 120° F. [48.9° C.]. The ES meter automatically applies an increasing voltage (from 0 volts) across an electrode gap in the probe. Maximum voltage that the solution will sustain across the gap before conducting current is displayed as the ES voltage.

HT-HP (high temperature-high pressure) volume was measured in an HT-HP pressure cell (500 psi and 120° C.) over 30 minutes. The HT-HP measurement provides a relative measurement of the permeability of a solution passing through a standard filter and provides a qualitative determination of the ability of the solution to seal a well bore and formation.

Plastic viscosity (PV) (mPa·s) was measured by a Bingham viscosity rotational viscometer. Plastic viscosity is a function of the shear stress exerted to maintain constant flow in a fluid. With drilling fluids, the plastic viscosity of the fluid provides a qualitative indication of the flow characteristics of the fluid when it is moving rapidly. In particular, plastic viscosity provides an indication of the ability of the fluid to disperse solids within the solution. Generally, a lower plastic viscosity (i.e. a lower slope in a shear vs. shear-stress plot) is preferred to optimize the hole cleaning parameters for a drilling fluid. That is, the lower the PV relative to its YP produces a greater shear thinning fluid and as a result improves hole cleaning while at the same time reducing bit viscosities and increasing rate of penetration (ROP).

Yield point (YP) is the y axis intercept of the plastic viscosity plot (shear-rate (x-axis) versus shear-stress (y-axis) plot) and describes the flow characteristics of a drilling solution when it is moving very slowly or at rest. The yield point provides a qualitative measurement of the ability of a mud to lift cuttings out of the annulus. A high YP implies a non-Newtonian fluid and a fluid that carries drill cuttings better than a fluid of similar density but lower YP.

Filter cake is the measurement of the thickness of the filter residue in an HT-HP filter press. Generally, it is preferred that the drilling fluid causes the formation of a thinner filter cake.

### B. Effect of Montan Wax on Fluid Parameters

A base fluid was prepared as above and increasing amounts of Montan wax added as primary emulsifier as shown in Table 2. Montan wax is a fossilized plant wax comprising non-glyceride long-chain (C24-C30) carboxylic acid esters (62-68 weight %), free long-chain organic acids (22-26%), long-chain alcohols, ketones and hydrocarbons (7-15%) and resins. It has a melting point of approximately 82-95° C.

TABLE 2
Effect of Montan Wax as Primary Emulsifier

| | Sample# | | | | | | | | | |
|---|---|---|---|---|---|---|---|---|---|---|
| | 1 | | 2 | | 3 | | 4 | | 5 | |
| Distillate 822 Premix B920 | 350 | mls | 350 | mls | 350 | mls | 350 | mls | 350 | mls |
| Montan Wax | 0.0 | g | 1.0 | g | 2.0 | g | 3.0 | g | 3.0 | g |

BHR (Before Hot Rolling)

| | | | | | |
|---|---|---|---|---|---|
| Ø600 | 28 | 28 | 27 | 29 | 29 |
| Ø300 | 18 | 18 | 17 | 18 | 18 |
| Ø200 | 14.5 | 14 | 13 | 14 | 14 |
| Ø100 | 10 | 10 | 9 | 9 | 9 |
| Ø6 | 4 | 3.5 | 3 | 3 | 3 |
| Ø3 | 3.5 | 3 | 3 | 2.75 | 2.75 |
| Emulsion Stability (volts) | 1165 | 1209 | 1268 | 1347 | 1347 |
| Emulsion Stability (2) | 1117 | 1139 | 1148 | 1295 | 1295 |
| Emulsion Stability (3) | 1029 | 1111 | 1118 | 1244 | 1244 |
| Plastic Viscosity (mPa · s) | 10 | 10 | 10 | 11 | 11 |
| Yield Point (Pa) | 4.0 | 4.0 | 3.5 | 3.5 | 3.5 |
| HT-HP Filtrate @ 110 C. (mls) | 16.4 | 15.0 | 12.0 | 10.0 | 10.0 |
| Filter Cake (mm) | 2.00 | 1.00 | 0.50 | 0.25 | 0.25 |

The results shown in Table 2 indicate that with increasing Montan wax:
the HT-HP volume is reduced;
emulsion stability increased;
yield point dropped; and,
the filter cake thickness decreased.

Thus, Montan wax is effective as a primary emulsifier while maintaining good fluid properties, particularly in reducing filter cake.

### C. Effect of Different Waxes on Fluid Parameters

A base fluid was prepared with Drillsol™ (Enerchem) as the primary phase. Drillsol is a middle distillate hydrocarbon drilling fluid. Different waxes were added to the base fluid as primary emulsifier in the amounts as shown in Tables 3 and 4. The waxes included plant, animal and mineral derived waxes including Beeswax, Candelilla, Carnauba, Ceresine, Montan, Shellac, and Crude Canola. In the past crude Canola has been successfully as an Emulsifier, HT-HP fluid loss control agent, and as a Rheology Modifier. As such, its use in this work was to provide a benchmark against which the waxes could be compared. The formulations shown in Table 3 included additional drilling fluid additives namely water, calcium chloride and lime. Table 4 shows fluid formulations as in Table 3 but without water, calcium chloride and lime.

TABLE 3
Effect of Different Waxes as Primary Emulsifier within an Oil-based Drilling Fluid

| | Sample# | | | | | | | | | | | | | |
|---|---|---|---|---|---|---|---|---|---|---|---|---|---|---|
| | 6 | | 7 | | 8 | | 9 | | 10 | | 11 | | 12 | |
| Drillsol (mls) | 315 | | 315 | | 315 | | 315 | | 315 | | 315 | | 315 | |
| Bentone 150 | 4.0 | g | 4.0 | g | 4.0 | g | 4.0 | g | 4.0 | g | 4.0 | g | 4.0 | g |
| H₂O | 35.0 | g | 35.0 | g | 35.0 | g | 35.0 | g | 35.0 | g | 35.0 | g | 35.0 | g |
| CaCl₂ | 8.8 | g | 8.8 | g | 8.8 | g | 8.8 | g | 8.8 | g | 8.8 | g | 8.8 | g |
| CaO | 5.0 | g | 5.0 | g | 5.0 | g | 5.0 | g | 5.0 | g | 5.0 | g | 5.0 | g |
| Beeswax | 4.0 | g | | | | | | | | | | | | |
| Candelilla Wax | | | 4.0 | g | | | | | | | | | | |
| Carnauba Wax | | | | | 4.0 | g | | | | | | | | |
| Ceresine Wax | | | | | | | 4.0 | g | | | | | | |
| Montan Wax | | | | | | | | | 4.0 | g | | | | |
| Shellac Wax | | | | | | | | | | | 4.0 | g | | |
| Crude Canola | | | | | | | | | | | | | 4.00 | g |

AHR (after hot rolling) @ 150° C.

| Rheology | | | | | | | | | | | | | | |
|---|---|---|---|---|---|---|---|---|---|---|---|---|---|---|
| (Temperature | | | | | | | | | | | | | | |
| 50° C.) | | | | | | | | | | | | | | |
| Ø600 | 22.5 | | 20 | | 20 | | 29 | | 20.5 | | 20 | | 26 | |
| Ø300 | 14 | | 12 | | 11 | | 20 | | 12 | | 12 | | 16 | |
| Ø200 | 11 | | 9 | | 8 | | 16.5 | | 9 | | 9 | | 13 | |
| Ø100 | 7 | | 5.5 | | 5 | | 12.5 | | 5.5 | | 5.5 | | 9 | |
| Ø6 | 2.5 | | 1.5 | | 1 | | 9.5 | | 1.5 | | 1.5 | | 5.5 | |
| Ø3 | 2 | | 1 | | 0.5 | | 9.5 | | 1 | | 1 | | 5.5 | |
| Emulsion | 657 | volts | 1072 | volts | 2039 | volts | 869 | volts | 969 | volts | 1471 | volts | 1190 | volts |
| Stability (1) | | | | | | | | | | | | | | |
| Plastic Viscosity | 9 | mPa · s | 8 | mPa · s | 9 | mPa · s | 9 | mPa · s | 9 | mPa · s | 8 | mPa · s | 10 | mPa · s |
| Yield Point | 2.8 | Pa | 2.0 | Pa | 1.0 | Pa | 5.5 | Pa | 1.8 | Pa | 2.0 | Pa | 3.0 | Pa |
| HT-HP Filtrate | 16.2 | mls | 14.4 | mls | 17.8 | mls | 56.0 | mls | 21.6 | mls | 18.6 | mls | 42.8 | mls |
| 110° C. | | | | | | | | | | | | | | |
| Filter Cake | 0.25 | mm | 0.25 | mm | 1.00 | mm | 10.00 | mm | 0.50 | mm | 0.25 | mm | 1.00 | mm |

TABLE 4
Effect of Different Waxes on Oil/Wax Mixture

| | Sample# | | | | | | | | | | | | | |
|---|---|---|---|---|---|---|---|---|---|---|---|---|---|---|
| | 13 | | 14 | | 15 | | 16 | | 17 | | 18 | | 19 | |
| Distillate 822 Premix B920 | 350 | mls | 350 | mls | 350 | mls | 350 | mls | 350 | mls | 350 | mls | 350 | mls |
| Beeswax | | | 4.0 | g | | | | | | | | | | |
| Candelilla Wax | | | | | 4.0 | g | | | | | | | | |
| Carnauba Wax | | | | | | | 4.0 | g | | | | | | |
| Ceresine Wax | | | | | | | | | 4.0 | g | | | | |
| Montan Wax | | | | | | | | | | | 4.0 | g | | |
| Shellac Wax | | | | | | | | | | | | | 4.0 | g |

| | | | | | | | |
|---|---|---|---|---|---|---|---|
| Rheology (T = 50° C.) | | | | | | | |
| Ø600 | 34.5 | 35 | 35 | 36.5 | 35 | 35.5 | 37 |
| Ø300 | 22 | 22 | 22 | 23 | 22 | 22.5 | 23.5 |
| Ø200 | 17 | 17 | 17 | 18 | 17 | 17 | 18 |
| Ø100 | 11.5 | 11.5 | 11.5 | 12 | 11.5 | 11.5 | 12 |
| Ø6 | 5 | 5 | 4.5 | 5 | 4.5 | 4.5 | 5 |
| Ø3 | 4.5 | 4.5 | 4 | 4.5 | 4 | 4 | 4.5 |
| Emulsion Stability (V) | 1863 | 1978 | 1931 | 1980 | 1842 | 1962 | 2060 |
| Plastic Viscosity (mPa · s) | 12.5 | 13.0 | 13.0 | 13.5 | 13.0 | 13.0 | 13.5 |
| Yield Point (Pa) | 4.75 | 4.50 | 4.50 | 4.75 | 4.50 | 4.75 | 5.00 |
| HT-HP Filtrate (110° C.) | 7.2 | 6.6 | 5.8 | 6.4 | 6.6 | 5.2 | 6.8 |
| (mls) | | | | | | | |
| Filter Cake (mm) | 0.25 | 0.25 | 0.25 | 0.25 | 0.25 | 0.25 | 0.25 |

The results shown in Tables 3 and 4 indicate that each wax provided acceptable fluid properties; as compared to either the baseline fluid or to Canola Oil, for use as an oil-based drilling fluid. In particular, each of Beeswax, Candelilla, Carnauba, Ceresine, Montan, Shellac and Crude Canola showed acceptable viscosity, emulsion stability, and plastic viscosity. In the case of ceresine and crude canola, yield point, HT-HP filtrate and filter cake values were higher than normally accepted values.

### D. Effect of Waxes and Coal Powders as Seepage Control Agents

In addition, compositions including wax and various low density powders and blends were investigated for their effectiveness as seepage control agents.

### a) Experimental

The effectiveness of various additives as seepage control agents was measured in an API press. Mixtures were prepared and 350 ml samples of each mixture were pushed through a porous media (API Filter Paper) over a maximum 30 minute time period. The volume of filtrate passing through the porous media was measured together with the time taken. If the full volume of the mixture did not pass through the mixture, a maximum 30 minute time period was recorded. The volume of the filtrate was also recorded. A lower filtrate volume (less than 50 ml) indicated that the mixture was effective in sealing the porous media. A high filtrate volume and time period less than 30 minutes indicated that the mixture was not effective as a seepage control agent.

The additives were compared to a similar 350 ml solution containing calcium carbonate as a seepage control agent. The full volume of the calcium carbonate solution passed through the porous media in approximately 10 seconds.

The following waxes and powders were investigated as shown in Table 5:

TABLE 5
Waxes/Powders

| | ASG |
|---|---|
| Powder | (kg/m³) |
| Black Earth Powder | 800 |
| Black Earth Super Fine | 800 |
| C07-392 Charcoal Dust | 830 |
| C07-393 Sub-bituminous Coal | 830 |
| dust | |
| Gilsonite | 1060 |
| Montan Wax | 1000 |
| Beeswax | 960 |
| Ceresine (Paraffin) | 720 |
| Candelilla Wax | 960 |
| Carnauba Wax | 995 |

### b) Gilsonite

Gilsonite is a class of solid bitumens known as asphaltites. The properties of gilsonite include a high asphaltene content, a high solubility in organic solvents, a high molecular weight and a high nitrogen content.

Gilsonite is available in different grades generally categorized by softening point. The softening point is used as an approximate guide to its melt viscosity and behaviour in solution. The chemical differences are generally small between gilsonite grades, with only subtle variations in average molecular weight and asphaltene/resin-oil ratios. Gilsonite includes a significant aromatic fraction and most of the aromatics exist in stable, conjugated systems, including porphyrin-like structures. The remainder of the product consists of long, paraffinic chains.

The particle sizes of the fine and coarse gilsonite are shown in FIG. 6A.

Table 6B shows the typical component analysis (wt %) for different gilsonites and the corresponding softening points.

TABLE 6A
Gilsonite Particle Size Distribution

| | % |
|---|---|
| | Retained |
| Coarse | |
| Gilsonite | |
| +4 mesh | 0 |
| +10 mesh | 5-10 |
| +65 mesh | 70-90 |
| +150 mesh | 90-95 |
| Gilsonite (Fine) | |
| +10 mesh | — |
| +35 mesh | 0 |
| +65 mesh | <=1 |
| +100 mesh | <=5 |
| +200 mesh | <=20 |

TABLE 6B
Component Analysis and Softening Points of Gilsonites
Typical Component Analysis (wt %)

| | | | | |
|---|---|---|---|---|
| Asphaltenes | 57 | 66 | 71 | 76 |
| Resins | 37 | 30 | 27 | 21 |
| (Maltenes) | | | | |
| Oils | 6 | 4 | 2 | 3 |
| Total | 100 | 100 | 100 | 100 |
| Softening Point, | 290 | 320 | 350 | 375 |
| ° F. | | | | |

A notable feature of gilsonite is its high nitrogen content (3.3 wt %, typical), which is present mainly as pyrrole, pyridine, and amide functional groups. Phenolic and carbonyl groups are also present. The low oxygen content relative to nitrogen suggests that much of the nitrogen has basic functionality and likely accounts for the surface wetting properties and resistance to free radical oxidation. The average molecular weight of Gilsonite is about 3000. This is high relative to other asphalt products and to most synthetic resins and likely contributes to gilsonite's “semi-polymeric” behaviour when used as a modifying resin in polymeric and elastomeric systems. There is some reactive potential in gilsonite and crosslinking and addition type reactions have been observed.

### c) Leonardites

Leonardites (also referred to as humates and lignites) include mined lignin, brown coal, and slack and are an important constituent to the oil well, drilling industry. Leonardites, as known to those skilled in the art and within this description refer to the general class of compounds. Lignite is technically known as a low rank coal between peat and sub-bituminous and is given to products having a high content of humic acid. The lignite used in the following tests was from the Dakota Deposit.

With reference to Tables 7a-7f, the effectiveness of various blends of oil, waxes and powders as seepage control agents was compared. Table 7a shows Runs 1-4 that included various blends of Montan wax, coarse or fine gilsonite, and lignite.

TABLE 7a
Seepage Control Blends and Results

| | Run # | | | | | | | |
|---|---|---|---|---|---|---|---|---|
| | 1 | | 2 | | 3 | | 4 | |
| Distillate 822 | 350 | mls | 350 | mls | 350 | mls | 350 | mls |
| Montan | 5 | gms | 5 | gms | 10 | gms | 10 | gms |
| Gilsonite HT | 5 | gms | | | 10 | gms | | |
| Gilsonite | | | 5 | gms | | | 10 | gms |
| Coarse | | | | | | | | |
| Lignite | 5 | gms | 5 | gms | | | | |
| API @ 100 psi | 75 | mls | 70 | mls | 47 | mls | 2 | mls |
| Time | 30 | min | 30 | min | 30 | min | 30 | min |

The results shown in Table 7a (Runs 1 and 2) compare the effectiveness of coarse and fine gilsonite as a seepage control agent in a blend including Montan wax, coarse or fine gilsonite, and lignite. The results of runs 1 and 2 show that there was no significant difference using coarse or fine gilsonite.

Runs 3 and 4 compare the effectiveness of coarse and fine gilsonite as a seepage control agent in blends including an increased amount of Montan wax and coarse and fine gilsonite in the absence of lignite. The results indicate that both coarse and fine gilsonite are very effective as a seepage control agent when blended with Montan wax. The results show that coarse gilsonite was significantly better.

TABLE 7b
Seepage Control Blends and Results

| | Run # | | | | | | | | | | | |
|---|---|---|---|---|---|---|---|---|---|---|---|---|
| | 5 | | 6 | | 7 | | 8 | | 9 | | 10 | |
| Distillate 822 | 350 | mls | 350 | mls | 350 | mls | 350 | mls | 350 | mls | 350 | mls |
| Beeswax | 7 | gms | | | | | | | | | | |
| Carnauba | | | 7 | gms | | | | | | | | |
| Candelilla | | | | | 7 | gms | | | | | | |
| Ceresine (Paraffin) | | | | | | | 7 | gms | | | | |
| Montan | | | | | | | | | 7 | gms | | |
| Shellac | | | | | | | | | | | 7 | gms |
| Gilsonite Coarse | 7 | gms | 7 | gms | 7 | gms | 7 | gms | 7 | gms | 7 | gms |
| Black Earth Superfine | 7 | gms | 7 | gms | 7 | gms | 7 | gms | 7 | gms | 7 | gms |
| (Lignite) | | | | | | | | | | | | |
| API @ 100 psi | 25 | mls | 85 | mls | 240 | mls | 350 | mls | 50 | mls | 280 | mls |
| Time | 30 | min | 30 | min | 30 | min | 7 | min | 30 | min | 30 | min |

The results shown in Table 7b (Runs 5-10) compare the effectiveness of various waxes blended with coarse gilsonite and black earth super fine as a seepage control agent. The results indicate that those blends including Beeswax and Montan wax in a blend including coarse gilsonite and black earth super fine are effective as a seepage control agent. Blends with Carnauba, Ceresine and Candellila were not effective.

TABLE 7c
Seepage Control Blends and Results

| | Run # | | | | | | | | | | | |
|---|---|---|---|---|---|---|---|---|---|---|---|---|
| | 11 | | 12 | | 13 | | 14 | | 15 | | 16 | |
| Distillate 822 | 350 | mls | 350 | mls | 350 | mls | 350 | mls | 350 | mls | 350 | mls |
| Montan | 7 | gms | 7 | gms | 7 | gms | 7 | gms | 7 | gms | 7 | gms |
| Gilsonite HT | 7 | gms | | | | | | | | | | |
| Gilsonite Coarse | | | 7 | gms | 7 | gms | 7 | gms | 7 | gms | 7 | gms |
| Lignite | 7 | gms | 7 | gms | | | | | | | | |
| Black Earth Powder (Lignite) | | | | | 7 | gms | | | | | | |
| C07-392 Char-cyclone dust | | | | | | | 7 | gms | 7 | gms | | |
| C07-393 DC-90 Coal dust | | | | | | | | | | | 7 | gms |
| API @ 100 psi | 60 | mls | 25 | mls | 13 | mls | 1.5 | mls | 4 | mls | 12 | mls |
| Time | 30 | min | 30 | min | 30 | min | 30 | min | 30 | min | 30 | min |

The results shown in Table 7c (Runs 11-16) compare the effectiveness of blends with Montan wax together with various combinations with coarse and fine gilsonite and/or coal dusts. The results indicate that blends including coarse gilsonite and C07-392 cyclone dust, C07-393 coal dust or lignite were the most effective blends.

TABLE 7d
Seepage Control Blends and Results

| | Run # | | | | | |
|---|---|---|---|---|---|---|
| | 17 | | 18 | | 19 | |
| Distillate 822 | 350 | mls | 350 | mls | 350 | mls |
| Shellac | 7 | gms | 7 | gms | 7 | gms |
| Gilsonite Coarse | 7 | gms | 7 | gms | 7 | gms |
| Black Earth Powder (Lignite) | 7 | gms | | | | |
| C07-392 Char-cyclone dust | | | 7 | gms | | |
| C07-393 DC-90 Coal dust | | | | | 7 | gms |
| API @ 100 psi | 150 | mls | 80 | mls | 60 | mls |
| Time | 30 | min | 30 | min | 30 | min |

The results shown in Table 7d (Runs 17-19) compare the effectiveness of blends of shellac together with coarse Gilsonite and various coal powders. The results indicate that blends incorporating shellac were not effective as seepage control agents.

TABLE 7e
Seepage Control Blends and Results

| | Run # | | | | | | | | | |
|---|---|---|---|---|---|---|---|---|---|---|
| | 20 | | 21 | | 22 | | 23 | | 24 | |
| Distillate 822 | 350 | mls | 350 | mls | 350 | mls | 350 | mls | 350 | mls |
| Lignite | 20 | gms | | | | | | | | |
| Black Earth Powder (Lignite) | | | 20 | gms | | | | | | |
| Black Earth Superfine (Lignite) | | | | | 20 | gms | | | | |
| C07-392 Char-cyclone dust | | | | | | | 20 | gms | | |
| C07-393 DC-90 Coal dust | | | | | | | | | 20 | gms |
| API @ 100 psi | 350 | mls | 350 | mls | 350 | mls | 350 | mls | 350 | mls |
| Time | 10 | min | 15 | min | 14 | min | 4 | min | 1 | min |

The results shown in Table 7e (runs 20-24) compared the effectiveness of blending various coal powders with Distillate 822 and no additional additives. The results show that coal powders in the absence of other additives are not effective as a seepage control agent.

TABLE 7f
Seepage Control Blends and Results

| | Run # | | | | | | | |
|---|---|---|---|---|---|---|---|---|
| | 25 | | 26 | | 27 | | 28 | |
| Distillate 822 | 350 | mls | 350 | mls | 350 | mls | 350 | mls |
| Montan | | | | | 10 | gms | 10 | gms |
| Gilsonite HT | 10 | gms | | | | | | |
| Gilsonite | | | 10 | gms | | | | |
| Coarse | | | | | | | | |
| Lignite | 10 | gms | | | 10 | gms | | |
| C07-393 | | | 10 | gms | | | 10 | gms |
| DC-90 | | | | | | | | |
| Coal dust | | | | | | | | |
| API @ 100 psi | 350 | mls | 350 | mls | 200 | mls | 80 | mls |
| Time | 10 | min | 7 | min | 30 | min | 30 | min |

The results shown in Table 7f (runs 25-28) compared the effectiveness of blends including Montan wax, coarse, fine or no gilsonite and/or lignite powder or C07-393 DC-90 coal dust. The results show that coarse or fine gilsonite together with lignite or coal dust were not effective as a seepage control agent. The results show that blends including Montan wax with lignite or coal dust were also not effective as seepage control agents.

### E. Results

In summary, the results show that:
1. the combination of Montan wax and coarse or fine gilsonite (Runs 3 and 4) provide good SC;
2. If lignite is added, SC decreases (Runs 1 and 2);
3. Both Beeswax and Montan wax combined with black earth super-fine and coarse gilsonite provide good SC (Runs 5 and 9); and,
4. Montan wax combined with coarse gilsonite and coal powders provide good SC (Runs 12-16).

### F. Discussion

The results show that Montan wax and Beeswax are effective seepage control agents when combined with coarse or fine gilsonite and/or various coal powders. Unexpectedly, blends including coarse gilsonite provided superior SC compared to fine gilsonite. It is believed that the compositions are effective as seepage control agents as a result of the interactions between the long-chain waxes, the plastically deformable gilsonites and insoluble coal powders. The larger gilsonite particles may provide better SC as the plastic deformation and swelling of the larger particles in the hydrocarbon phase is higher thus providing a firmer or solid matrix of particles against which insoluble coal particles can interact with. The long chain wax particles may also provide a web into which the coal particles may seat. This is contrasted with calcium carbonate that does not swell or plastically deform in the hydrocarbon phase.

A comparison of the properties of a 50/50 Montan wax/gilsonite mixture, lignite, calcium carbonate and paraffin wax are shown in Table 7.

TABLE 7
Property Comparison

| | 50/50 Montan | | Calcium | |
|---|---|---|---|---|
| Property | Wax/Gilsonite | Lignite | Carbonate | Paraffin |
| Hydrophilic (Water dispersible) | | | • | |
| Hydrophobic | • | • | | • |
| Lipophilic (Oil dispersible) | • | • | | • |
| Dissolves Completely in | | | | • |
| Hydrocarbon | | | | |
| Plastic Deformation in Oils | • | • | | • |
| Reduces Oil mud Density | • | • | | |
| Increases Oil Mud Density | | | • | |
| Removable by Centrifuging | | | • | |
| Consumes emulsifiers in order | | | • | |
| to oil wet | | | | |
| Reduces emulsion Stability | | | • | |
| Available in range of sizes | • | | • | |
| Emulsifier | • | • | | |
| Oil Wetting Agent | • | • | | |
| HT-HP Fluid loss control | • | • | | |
| Torque Reduction | • | | | |
| Drag Reduction | • | | | |
| Requires Coarse Screens | • | | | • |
| initially | | | | |
| Density | 800 kg/m3 | 800 kg/m3 | 2650 kg/m3 | 900 kg/m3 |
| Volume equivalent to Calcium | ⅓ | ⅓ | 1 | ⅓ |
| Carbonate | | | | |

Importantly, the compositions in accordance with the invention enable the operator to ameliorate the cost of seepage control agents by incorporating into drilling solutions less expensive additives that are effective in seepage control. Generally, both gilsonite and Montan wax are “medium” cost products. By introducing cheaper cost coal powders, the amounts of gilsonite and Montan wax can be reduced thus lowering the overall cost of the drilling fluid while still providing an effective seepage control product.

Still further, by eliminating high density calcium carbonate, the overall density of the drilling fluid is substantially reduced thus reducing the seepage control losses due to hydrostatic pressure. By using lower density SC agents in small concentrations in base oils that have ASG's of 760 kg/m³ to 870 kg/m³ the increase in fluid density is marginal when compared to calcium carbonate. Also these materials present advantages by their lighter density as they will remain suspended when subjected to solids separation equipment (such as centrifuges and hydrocyclones) that are used to remove high density materials drilled solids.

### G. Field Results

A blend of Montan wax, lignite and coarse gilsonite was field tested. Prior to introduction of the mixture, the well was observing fluid losses at approximately 2.5 m³/hr. After the addition of the blend, fluid losses were 0.6 m³/hr. Over the course of the drilling program, it was estimated that the operator saved $200,000 in drilling fluid costs.

Although the present invention has been described and illustrated with respect to preferred embodiments and preferred uses thereof, it is not to be so limited since modifications and changes can be made therein which are within the full, intended scope of the invention.

1. A method for controlling the viscosity of an oil and water emulsion comprising the step of introducing an effective amount of an emulsifier to an oil and water emulsion containing organophilic clay (OC) to produce a desired viscosity in the emulsion wherein the emulsifier is selected from any one of: beeswax, candelilla wax, carnauba wax, ceresine wax, Montan wax, and shellac.

2. A method as in claim 1 wherein the amount of emulsifier and organophilic clay are selected to maximize the performance of the organophilic clay for the desired viscosity.

3. A method as in claim 1 wherein the amounts of organophilic clay and emulsifier are balanced to minimize the amount of organophilic clay for a desired viscosity and the amount of emulsifier is sequentially increased to produce the desired viscosity.

4. A method as in claim 1 wherein the emulsifier is selected to improve the seepage control properties of the emulsion.

5. A method as in claim 1 wherein the emulsifier is Montan wax.

6. A method as in claim 1 further comprising the step of blending an effective amount of gilsonite into the emulsion for seepage control.

7. A method as in claim 6 wherein greater than 90% of the gilsonite has a particle size of greater than 150 mesh.

8. A method as in claim 6 wherein greater than 80% of the gilsonite has a particle size of smaller than 200 mesh.

9. A method as in claim 6 further comprising the step of blending an effective amount of a leonardite into the emulsion as a secondary seepage control agent.

10. A method as in claim 9 wherein the leonardite is any one of or a combination of a lignite or a coal dust.

11. A method as in claim 1 wherein the emulsifier is beeswax.

12. A method as in claim 11 further comprising the step of blending an effective amount of gilsonite into the emulsion for seepage control.

13. A method as in claim 12 wherein greater than 90% of the gilsonite has a particle size of greater than 150 mesh.

14. A method as in claim 12 wherein greater than 80% of the gilsonite has a particle size of smaller than 200 mesh.

15. A method as in claim 11 further comprising the step of blending an effective amount of a leonardite into the emulsion as a secondary seepage control agent.

16. A method as in claim 9 wherein the leonardite is any one of or a combination of a lignite or a coal dust.

17. A drilling fluid emulsion comprising:
a hydrocarbon continuous phase;
a water dispersed phase;
an organophilic clay; and,
an emulsifier selected from beeswax, candelilla wax, carnauba wax, ceresine wax, Montan wax, and shellac to produce a desired viscosity in the emulsion.

18. A drilling fluid emulsion as in claim 17 wherein the amounts of emulsifier and organophilic clay maximize the performance of the organophilic clay for the desired viscosity.

19. A drilling fluid emulsion as in claim 17 wherein the organophilic clay and emulsifier are balanced to minimize the amount of organophilic clay to produce the desired viscosity.

20. A drilling fluid emulsion as in claim 17 wherein the emulsifier is Montan wax and the emulsion further includes a gilsonite seepage control agent.

21. A drilling fluid emulsion as in claim 20 wherein greater than 90% of the gilsonite has a particle size of greater than 150 mesh.

22. A drilling fluid emulsion as in claim 20 wherein greater than 80% of the gilsonite has a particle size of smaller than 200 mesh.

23. A drilling fluid emulsion as in claim 20 further comprising a leonardite as a secondary seepage control agent.

24. A drilling fluid emulsion as in claim 23 wherein the leonardite is any one of or a combination of a lignite or a coal dust.

25. A drilling fluid emulsion as in claim 17 wherein the emulsifier is beeswax and the emulsion further includes a gilsonite seepage control agent.

26. A drilling fluid emulsion as in claim 25 wherein greater than 90% of the gilsonite has a particle size of greater than 150 mesh.

27. A drilling fluid emulsion as in claim 25 wherein greater than 80% of the gilsonite has a particle size of smaller than 200 mesh.

28. A drilling fluid emulsion as in claim 25 further comprising a leonardite as a secondary seepage control agent.

29. A drilling fluid emulsion as in claim 28 wherein the leonardite is any one of or a combination of a lignite or a coal dust.
